(19) United States
(12) Patent Application Publication
(10) Pub. No.: US 2003/0131337 A1
(43) Pub. Date: Jul. 10, 2003

(54) Educational method and tool for isolating and teaching programming language concepts

(76) Inventor: Asok K. Perumainar, Superior, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/041,022

(22) Filed: Jan. 7, 2002

(51) Int. Cl. G06F 9/44

(52) U.S. Cl. 717/100

(57) ABSTRACT

A method for teaching isolated concepts of a programming language. An interpreter interface with a code entry window adapted for receiving input is provided and a single code entry is received from the code entry window. The code entry is process and a visual cue is displayed. The code entry is compared to syntax rules for the programming language to identify syntax errors or the validity of the code entry syntax. When a syntax error is identified, an error code based on the syntax error is retrieved in the visual cue. The interpreter interface displays the error code, the received code entry, and previously processed code entries. When no errors are identified, the code entry is executed and a semantic view of the effects of executing the code entry is displayed showing the type, the name, and the value of variables declared and assigned in the code entry.

### BACKGROUND OF THE INVENTION

1. Field of the Invention

The present invention relates, in general, to education tools and systems for learning and teaching computer programming languages, and, more particularly, to an educational method and tool for isolating programming language concepts and providing visual and error cues for such isolated concepts to provide real time feedback to enhance user or student learning of language syntax and semantics.

2. Relevant Background

An ongoing challenge for the computer industry is teaching users or students computer programming languages. The task is similar to teaching a foreign language with each programming language being based on numerous general concepts that must be used and understood to successfully write programs or applications and to later debug and modify such applications. In addition to these general concepts, each language has its own command vocabulary that must be used with the proper syntax (i.e., the set of grammar rules in programming statements) to obtain desired results and minimize syntax errors. Once the general vocabulary and grammar is understood the programming student needs to understand the meaning of individual commands and combinations of commands or concepts, which can be thought of as understanding the language semantics or the semantic view or effect of the individual and combined programming concepts. Without this semantic understanding of the language, a programmer can write an application that when compiled and run has no syntax errors but provides an undesired or surprising result.

Existing educational method and tools fail to provide a learning environment conducive to learning both the syntactic and semantic aspects of programming language concepts. In a typical learning environment, the student is required to enter a number of lines of code or sets of programming statements and then compile and/or run the created application or subroutine. The student then can view the results or semantic view of the created set of program statement. However, the student cannot typically view the affects of individual statements or language concepts. Additionally, the student may be frustrated by individual syntax errors, such as improper use of punctuation and the like, that may force the student to individually correct or debug each programming statement. Interactive tutorials are sometimes used to teach programming languages, but the student is typically limited to following along with the creation of a specific and limited application and has little freedom to experiment with concepts of interest to them.

A number of programming tools have been developed to assist programmers in more efficiently writing applications, but each of these tools fails in some aspect in addressing the needs of programming students and especially, beginning programmers. For example, integrated development environment (IDE) products have been developed by a number of companies to support programming and typically include a program editor, a compiler, a debugger, and other software development tools. Existing IDEs sometimes allow a programmer to enter programming lines or statements for interpreting by a standard compiler. The IDE is generally provided in a graphical user interface in which error codes for improper syntax are provided. The user is not provided with visual cues as to the effect of the compiled statements and generally, there is no isolation of programming language concepts.

Debugging tools are available that provide pop up field or windows that allow a user to enter a correct value but usually do not allow a user to enter actual programming language statement or syntax. Additionally, debugging tools are generally designed for advanced programmers who are very familiar with the language syntax and semantics and do not want to be bothered with error cues and semantic views of the effects of changing syntax or input values. Shells and/or scripting languages are also used by programmers in writing applications by allowing a programmer to write and compile a script rather than writing, compiling, and running a full subroutine or class. Again, shells provide little or no isolation of language concepts and provide no visual cues for the effects of entered statements. Further, these programming tools are intended to make programming more efficient rather than teach the language and with this end in mind, are sometimes adapted to automatically correct common syntax errors without notifying the programmer of their mistake (e.g., assume user intended to enter a particular variable type consistent with previously entered statements). These and other features make existing tools unsuited as standalone programming language educational tools.

Hence, there remains a need for a tool for better teaching users or students programming concepts and skills. Preferably, such a tool would be able to isolate general language concepts and provide visual and error cues for such isolated concepts that would enhance learning of programming language syntax. Additionally, the tool would preferably provide a semantic view of the effect of isolated and combined concepts to enable a student to see in real time the effect of entered programming statements and variable values.

### SUMMARY OF THE INVENTION

The present invention addresses the above discussed and additional problems by providing a programming language educational system with a teaching tool. In one embodiment, the teaching tool is an application that can execute in a standalone format on any typical computing device, such as a server linked to user or student nodes to a communications network or on a user's desktop, laptop, or handheld computer. The teaching tool functions to facilitate learning of the syntax and semantics of a programming language, such as object-oriented languages like Java and non-object oriented languages. In general, the language syntax is taught by the teaching tool enabling a student to type a program statement or line of code. The tool verifies the syntactic correctness by interpreting the single line of code in accordance with the programming language specification, i.e., syntax and/or language rules. Any identified syntactic errors are then reported to the student with error cues. If the line of code passes this syntactic processing or test, the teaching tool executes the line of code and displays visual cues to show the student in real time the semantic implication of executing the single line of code. The learning environment is significantly enhanced by the combination of interpretation of single lines of codes, e.g., isolated language concepts, with the provision of visual and error cues illustrating the effect of the last executed statement.

More particularly, a method is provided in a computer system for isolating and teaching concepts of a programming language. The method includes providing an interpreter interface with a code entry portion or window adapted for receiving input from a user. Next, a single code entry is received from the user via the code entry portion. The method continues with processing the code entry, and in response to the processing, displaying a visual cue to the user. In one embodiment, the processing includes comparing syntax of the code entry to a set of syntax rules for the programming language to identify a syntax error or the validity of the code entry syntax. When a syntax error is identified, the method continues with retrieving an error code based on the syntax error and including an error code in the displayed visual cue. In a preferred embodiment, the visual cue further includes the received code entry.

The interpreter interface may include a code entry history portion for displaying the error code, the received code entry, and previously received and processed code entries. The processing of the method may include comparing the code entry to a set of syntax and language rules for the programming language to identify errors and when no errors are identified, executing the code entry. The visual cue preferably includes displaying a semantic view of the effects of executing the code entry. The semantic view may be a portion or window of the interpreter interface useful for displaying the type, the name, and the value of variables declared and assigned in the code entry. The method preferably is adapted to support teach object concepts and in these embodiments, the method includes displaying objects created by or manipulated by execution of the code entry.

### BRIEF DESCRIPTION OF THE DRAWINGS

FIG. 1 illustrates in block form a computer system with an education server executing a teaching tool application according to the present invention;

FIG. 2 is a flow diagram of an exemplary training session provided by the operation of the teaching tool of FIG. 1;

FIGS. 3-6 are screenshots illustrating various states of an exemplary interpreter interface provided by the teaching tool of FIG. 1 during an interactive training session; and

FIGS. 7-15 are screenshots illustrating states of an interpreter interface showing code entry and visual and error cues and screenshots illustrating semantic views provided by the display controller of the present invention showing the state and effects of code entered in the interpreter interface.

### DETAILED DESCRIPTION OF THE PREFERRED EMBODIMENTS

The present invention provides a programming language education method and system with a teaching tool for enhancing the learning environment for students by effectively isolating language concepts and providing visual and error cues to teach syntax and semantic aspects of the language. The teaching tool of the present invention is configured with a language concept interpreter and a display controller that work in combination to provide a useful learning environment. The tool functions to display an interpreter interface that allows a user or student to enter a single line of code or program statement and to then operate the interpreter to process the one line of code (or isolated language concept) against syntax and language rules for the particular language being learned.

The language concept interpreter, such as a Java interpreter specifically designed to compile one line of code at a time, then will provide error cues if a syntax error is detected or execute the line of code and display visual cues to assist in learning the semantic aspect of the line of code (e.g., the interpreter modifies the semantic view portion of the interpreter interface). The display controller is useful for creating a real time or current display of the effects of the executed code, such as by including created objects, arrays, and the like, in the controller display or controller window.

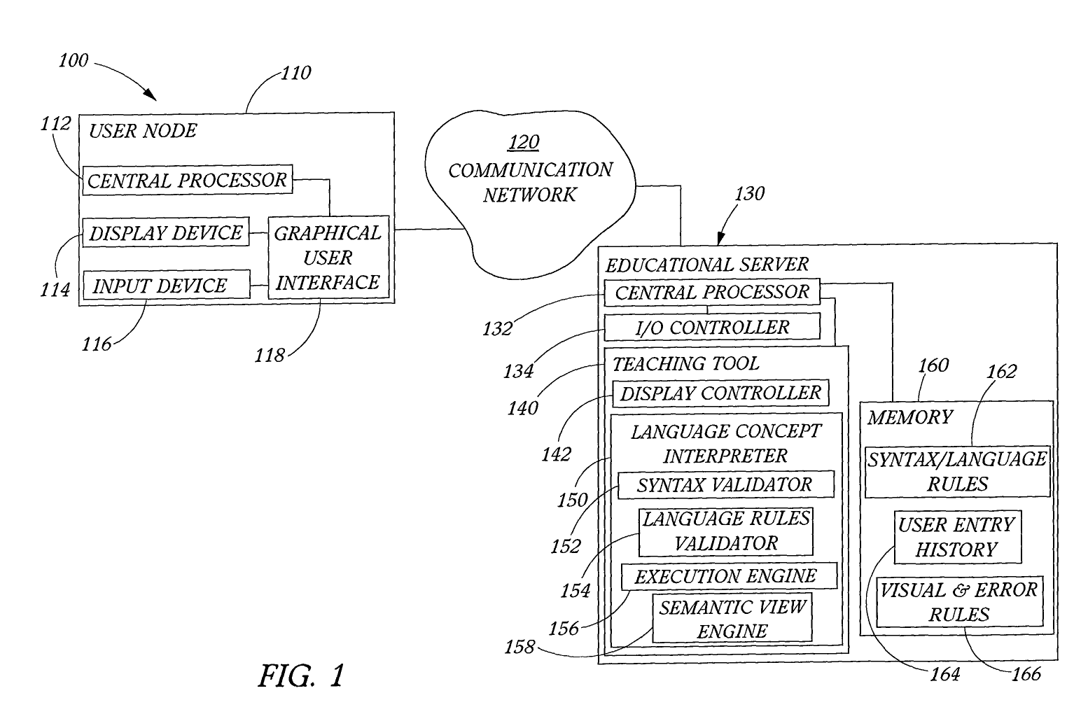

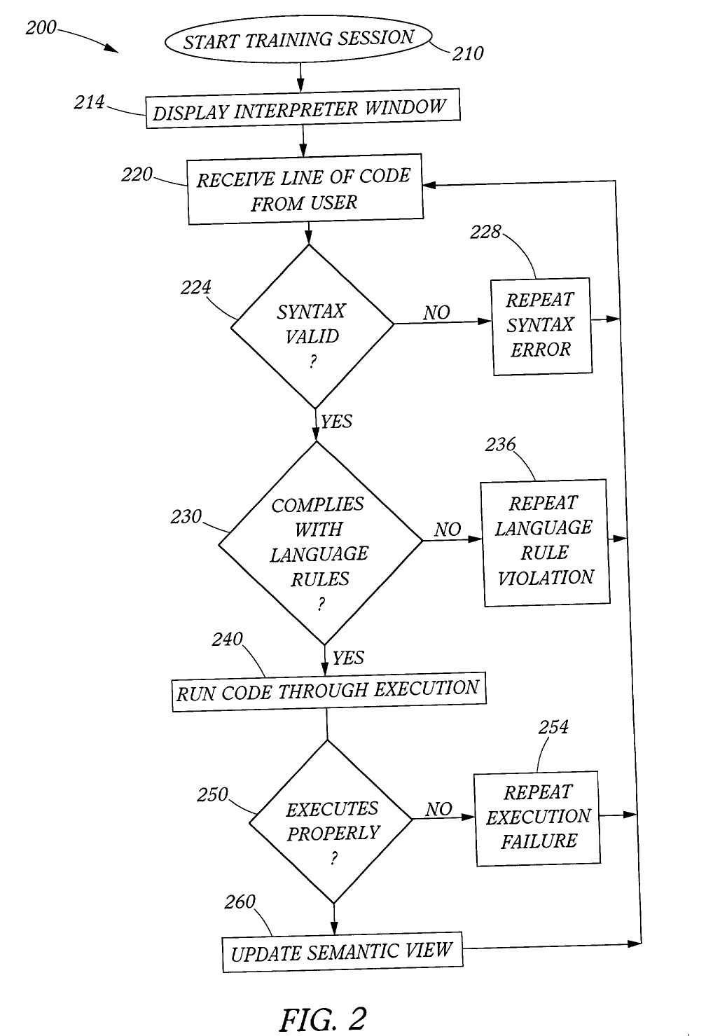

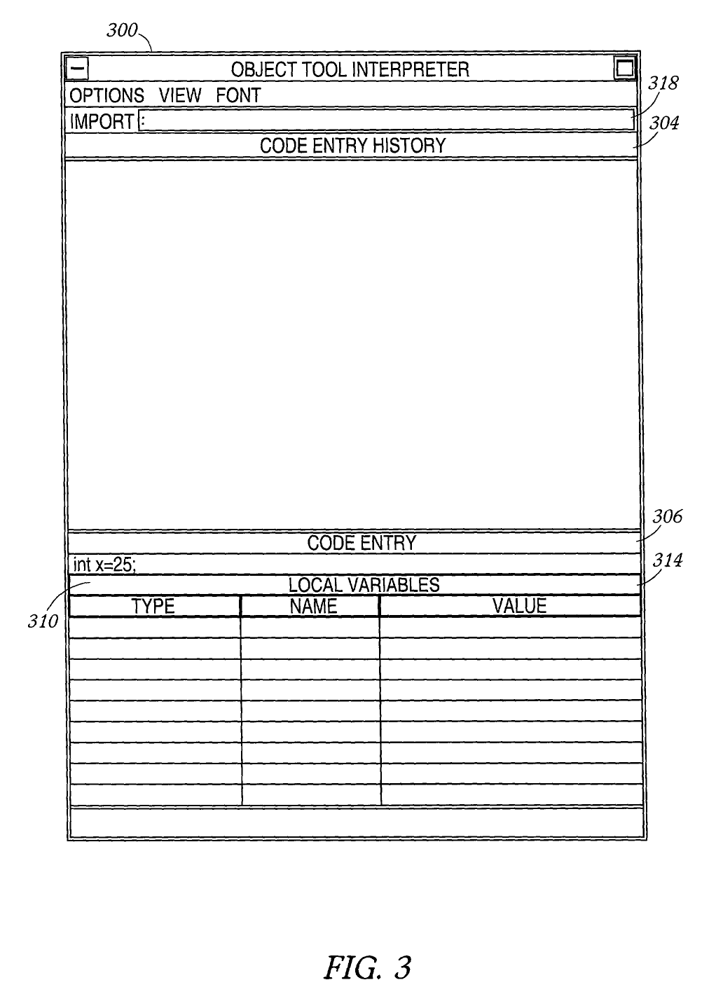

To fully describe the elements of the invention that provide concept isolation and visual and error cue display, the use of the teaching tool within a networked system is described with reference to FIG. 1. Of course, it will be understood that the teaching tool can be run on standalone computing devices and often will be distributed on storage media or over a communications network to be executed on such student devices including, but not limited, to desktop, laptop, notebook, handheld, and other computer devices or systems. The system level explanation of the invention is followed with a more detailed description of the general operation of the teaching tool during an exemplary training session with reference to FIG. 2. The following description uses Java as the underlying language being taught with the teaching tool, but the features of the teaching tool can readily be used and adapted for teaching other programming languages and language concepts. With reference to FIGS. 3-15, the operation of the teaching tool is further described with the use of a number of screen shots provided by the teaching tool on a user's monitor or display device during training sessions.

FIG. 1 illustrates one embodiment of a programming language educational system 100 useful for interactively training students in syntactic and semantic aspects of programming languages. The illustrated system 100 includes a user node 110 linked via a communications network 120 to an educational server 130 that is adapted to provide the unique learning environment of the present invention to an operator of the user node 110. The user node 110 includes a central processor (CPU) 112, a display device 114, an input device (such as a keyboard, a mouse, and the like) 116, and a graphical user interface 118 for allowing a user to enter lines of code and to otherwise provide input to the educational server 130 and to view interfaces and other information displayed by the educational server 130. The user node 110 may be nearly any electronic device useful for wired or wireless communication with the education server 130, such as personal computing devices or systems with a browser and network connection (e.g., a modem).

The functions and operation of the components in the system 100 are described in a client/server, decentralized computer network environment. While this is one useful implementation of the invention, those skilled in the arts will readily appreciate that the system 100 and its functions are transferable to many data communication systems that utilize numerous and varied data transfer techniques, which are considered within the breadth of this disclosure and the following claims. Further, in one preferred embodiment, the function and operation of the user node 110 and the educational server 130 are combined in a single device or system and the communications network 120 is eliminated.

As illustrated, the educational server 130 is communicatively linked to the user node 110 to provide the user node 110 with a remote training session via the communications network 120. The educational server 130 may be a standard web server or another device useful for running applications and storing data (or accessing data in a remote or a linked data storage unit). In the following discussion, network devices, such as the educational server 130 and the user node 110, are described in relation to their function rather than as particular electronic devices, and these network devices may be any devices useful for providing the described functions, including well-known data processing and communication devices and systems such as personal computers with processing, memory, and input/output components. The network devices may be server devices configured to maintain and then distribute software applications over the data communications network 120. The communication links between the components may be any suitable data communication link, wired or wireless, for transferring digital data between two electronic devices, and the communications network 120 may also be a number of standard networks or fabrics such as a LAN, a WAN, an Intranet, the Internet, and the like. In some cases, the teaching tool 140 and/or related information may even be transferred on storage mediums between the devices. Additionally, only one user node 110 and one educational server 130 are shown for simplifying the description but a typical system 100 would include numerous user nodes 110 served by one or more educational servers 130 via a one or more networks 120.

The educational server 130 includes a central processor (CPU) 132 for executing applications, an I/O controller 134 for processing communications received and sent over the network 120 (such as data input from the user node and information sent from the teaching tool 140 to the user node 110), and memory 160 storing syntax and language rules 162, user entry histories 164, and visual and error cues 166 (each of which is used by the teaching tool 140 as will be explained with reference to FIGS. 2-15). The rules 162 are created based on the particular language (or languages) being taught with the teaching tool 140 and are based on the programming language specification. Generally, the rules 162 are a subset of the syntax and language rules provided in such a specification but may include all of such rules. The visual and error cues 166 are stored prior to operating the teaching tool 140 and are specifically designed and selected to provide useful information to a student in real time. The cues 166 are typically linked to specific syntax and language errors and to specific programming language concepts (which are isolated by the teaching tool 140). Significantly, the educational server 130 includes the teaching tool 140 that functions to communicate with the user node 110 to provide an enhanced programming language learning environment. In one embodiment, the teaching tool 140 comprises a software program or one or more applications and/or modules installed on and executed by the educational server 130. The teaching tool 140 includes a display controller 142 that functions to display objects, arrays, and other items created by code entered by a user (e.g., to display a semantic view of executed code).

During operation, the teaching tool 140 enables a user to enter (such as with input device 116 via graphical user interface 118 and network 120) a programming statement or line of code. A language concept interpreter 150 is included in the tool 140 with syntax and language rules validators 152, 154 configured for processing entered program statements or lines of code against the syntax and language rules 162 for the underlying programming language (such as Java). Identified errors are reported with the use of the visual and error cues to the user, such as by displaying error messages in an interpreter interface viewable on the display device 114. If no errors are identified, an execution engine 156 is provided to execute the programming statement or line of code. The execution engine 156 may take a number of forms to provide this function. For example, in a Java embodiment, the execution engine may include a Java interpreter configured to compile one line of code at a time and to build on previously compiled and executed code. A semantic view engine 158 is provided in the interpreter 150 to update and display (or work with other components in creating a display) a semantic view of the executed code, i.e., the effect of the most recent line of code combined with other lines of code processed in the training session.

Exemplary operation of the teaching tool 140 and educational server 130 will now be described in more detail with reference to FIGS. 1 and 2. FIG. 2 illustrates an educational process or training session 200 carried out by the operation of the teaching tool 140. At 210, a training session 200 is begun, typically by executing the teaching tool 140, logging the user node 110 (or an operator of the node 110) into the educational server 130, and receiving a request from for a training session 200 from the user node 110. In a standalone embodiment, the training session 200 is begun 210 more simply by starting the teaching tool 140 (such as by selecting one or more icons in the graphical user interface 118). Of course, prior training sessions 200 may be saved in memory 160 or memory (not shown) on user node 110 and restarted at 210, which would allow previously code entry histories and semantic views to be saved without requiring a session 200 to begin a new session each time.

At 214, the teaching tool 140 operates to display an interpreter interface or window on the display device 114 including a window or box enabling a student to enter a single line of code in the programming language. In this fashion, the tool 140 is able to isolate programming concepts by processing and if appropriate, executing a single line of code (typically, containing one or a few programming concepts). At 220, the teaching tool 140 receives the entered line of code, such as via the graphical user interface 118 and the I/O controller 134. At 224, the syntax validator 152 of the interpreter 150 processes the input and received line of code against the syntax rules 162. If an error is detected, interpreter 150 retrieves an error code 166 corresponding to the detected or identified error and reports at 228 the error to the user by modifying a portion of the interpreter interface. For example, a code entry history window or screen may display the entered line of code and then display an error code useful for effectively allowing the user to understand the syntactic problem. The error code is typically a text statement but may include (or be exclusively) icons, figures, and the like useful for readily communicating an error to a programming student. In this manner, the user is provided prompt feedback on an entered line of code rather than being forced to enter multiple lines of code of an application and then debugging the entered set of code.

If the syntax of the line of code is valid, the training session 200 continues at 230 with the language rules validator 154 comparing the entered code with a set of language rules 162 from memory 160. If a language rule problem is identified, the interpreter 150 retrieves an error cue 166 corresponding to the identified language problem and reports at 236 the problem or violation to the user, such as by modifying the code entry history window of the interpreter interface or otherwise providing an indication of the language mistake. If no language or syntax problems are identified by the interpreter 150, the session 200 continues at 240 with the execution engine 156 executing the line of code.

Note, that execution at 250 is performed based on previously entered and executed lines of code such that the session 200 effectively builds on programming concepts already practiced by the student and allows the student to see how additional lines of code affect (e.g., semantic effects) previously created objects, arrays, and the like and/or previously declared and established variable values. At 250, the interpreter 150 determines if execution occurred properly and if not, the problem 254 is reported to the student via the interpreter interface. In one embodiment, the execution error is reported using a visual and/or error cue 166 from memory 160.

At 260, once execution is performed, the semantic engine 158 of the interpreter 150 acts to update the semantic view. For example, the interpreter interface may include local variables and such variables are modified at 260 to reflect execution of the most recent line of code. If appropriate, a semantic view of created objects, arrays, and the like in the interpreter interface or in a separate display window(s) such as a display controller window are updated to show the changes resulting from the execution of the single, isolated line of code. After updating the semantic view at 260, the training session 200 continues at 214 and 220 with the display of the interpreter interface or window and waiting for a next line of code to be input and/or received. As can be seen, the training session 200 provides an effective process for isolating programming concepts with single lines of code being interpreted. Additionally, the training session 200 creates a desirable educational environment by combining this single concept interpretation with the display of visual and error cues directed to adding to a student's understanding of both the syntactical and the semantic aspects of a programming language.

Now, with reference to FIGS. 3-15, operation of the teaching tool 140 in isolating language concepts and providing visual and error cues. To provide a more specific working example, the following discussion provides a number of cases where the teaching tool 140 is used to teach Java programming language concepts. The Java examples are useful for demonstrating how the tool features are useful for understanding creation and manipulation of objects. The teaching tool 140 is useful for teaching object-oriented languages such as Java and the “C++” languages but is also useful for many other languages (and the invention is not intended to be limited to a Java implementation).

FIG. 3 illustrates an exemplary interpreter interface or window 300 that is displayed by the language concept interpreter 154 during a training session. The interpreter interface 300 is shown as it would appear at the beginning of a session (e.g., prior to the entry and execution of a number of lines of code). As shown, the interpreter interface 300 includes a code entry history window 304 for displaying past entered lines of code and in a preferred embodiment, for displaying error codes. A code entry window 306 is also included to allow a user to enter (such as via a graphical user interface 118 with input device 116) a line of code having syntax expected and accepted within the programming language. To provide a semantic view of the effects of executed code, a local variables window 314 is provided having variable type, variable name, and variable value fields (or columns).

Further an import window is provided that in some embodiments of the tool 140 allows saved applications or portions of applications to be imported from memory 160 or other storage devices. For example, in one embodiment, the import window or portions of the menu are used by a student to import pre-created code snippets (e.g., two or more related lines of code). In this embodiment, the teaching tool 140 is adapted to allow the student to step through the lines of code in the snippet to process and execute (if no errors are found) each line of code (line by line, by selected groups of the lines of code, or as a complete snippet) without having to enter all of the lines of code themselves.

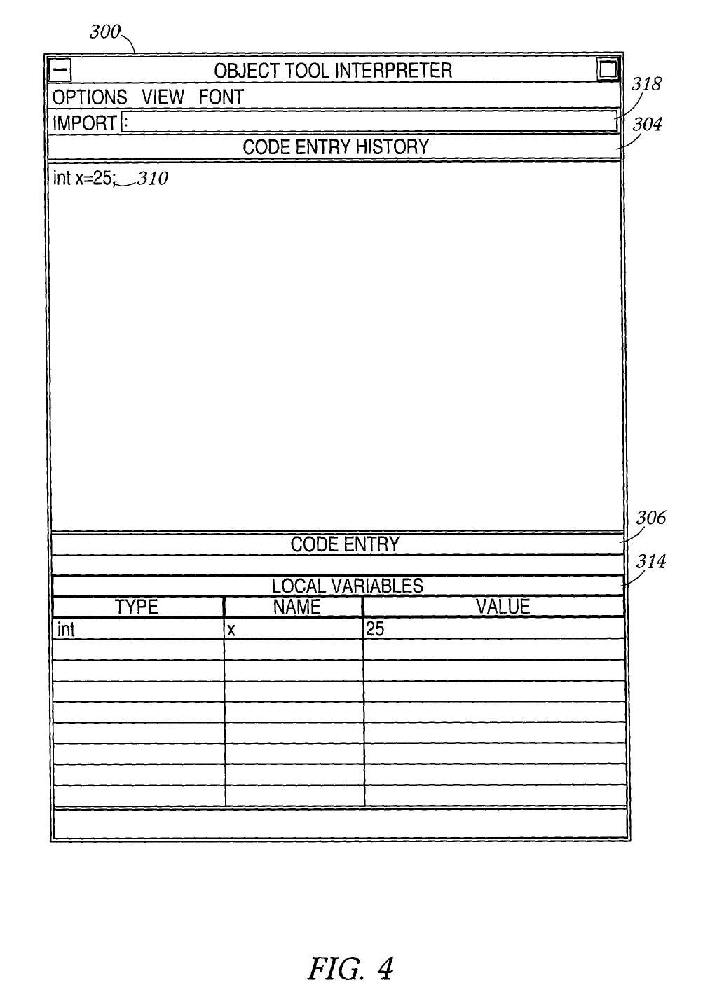

At 310, a single code entry (i.e., “int x=25;”) is shown entered or typed into the code entry window 306 to provide a variable declaration example. The user indicates that they are done entering code and for execution to begin, such as by pressing the enter or return key on a keyboard or by selecting a button (not shown) on the interface 300 with a mouse. The syntax validator 152 and language rules validator 154 operate to process the line of code 310 with the syntax and language rules 162. After processing the code entry and finding no errors, the interpreter 150 updates the code entry history window 304 by showing the entered code 310 as it was entered in code entry window 306. The semantic view in the local variables window 314 is updated, as shown in FIG. 4, to show the semantic effect of the executed code. This simple example quickly shows how effective the teaching tool 140 is at isolating a concept by allowing a single code entry to be compiled and executed plus showing the results of the single code entry's execution.

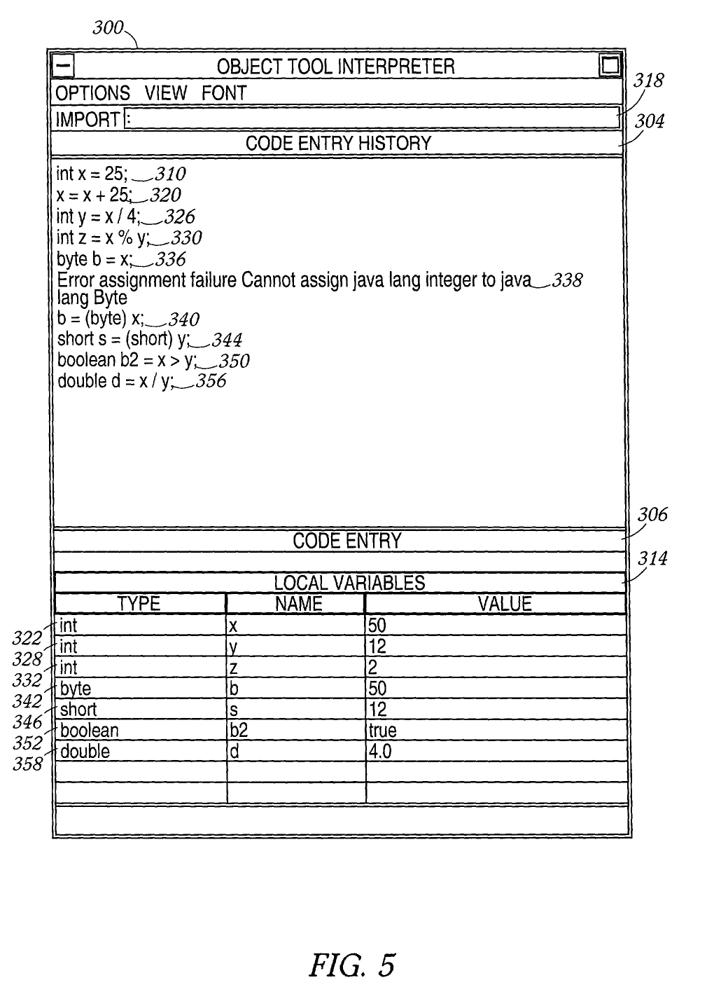

FIG. 5 illustrates the interpreter interface 300 after a number of additional code entries have been entered in code entry window 306 and after the code entries have been processed by the interpreter 154. These example code entries are useful for demonstrating simple binary operations and variable declarations using differences between variable types and restrictions in the assignments. Code entry 320 (i.e., “x=x+25;”) illustrates the use of the addition operator. The updating of the semantic view in the local variables 314 at 322 shows the change to the variable. The code entry 326 (i.e., “int y=x/4;”) shows the use of the division operator in a variable assignment statement and the updating of the semantic view in window 314 at 328 shows the results of the code execution and the use of an integer variable. Similarly, code entry 330 shows the use of the “%” Java operator and the semantic view entry 332 shows the effect of the execution of the code.

Continuing with the examples, the processing of code entry “byte b=x;” 336 is useful for illustrating the operation of the interpreter 150 in finding a syntax error in the code entry 336. The interpreter 150 then retrieves an error cue for the determined error and displays the error code 338 in code entry history 304 (but other locations can be used to provide this real time feedback to the user). In contrast, the code entry 340 has proper syntax which results in the code 340 being displayed in the code entry history 304 and the updating of the semantic view at 342 in local variables window 314. The short variable type is illustrated in entry 344 as well as the result of such a statement with semantic view entry 346. A Boolean variable declaration is shown with entry 350 and in semantic view 352. Similarly, a double variable declaration is shown with code entry 356 and semantic view entry 358.

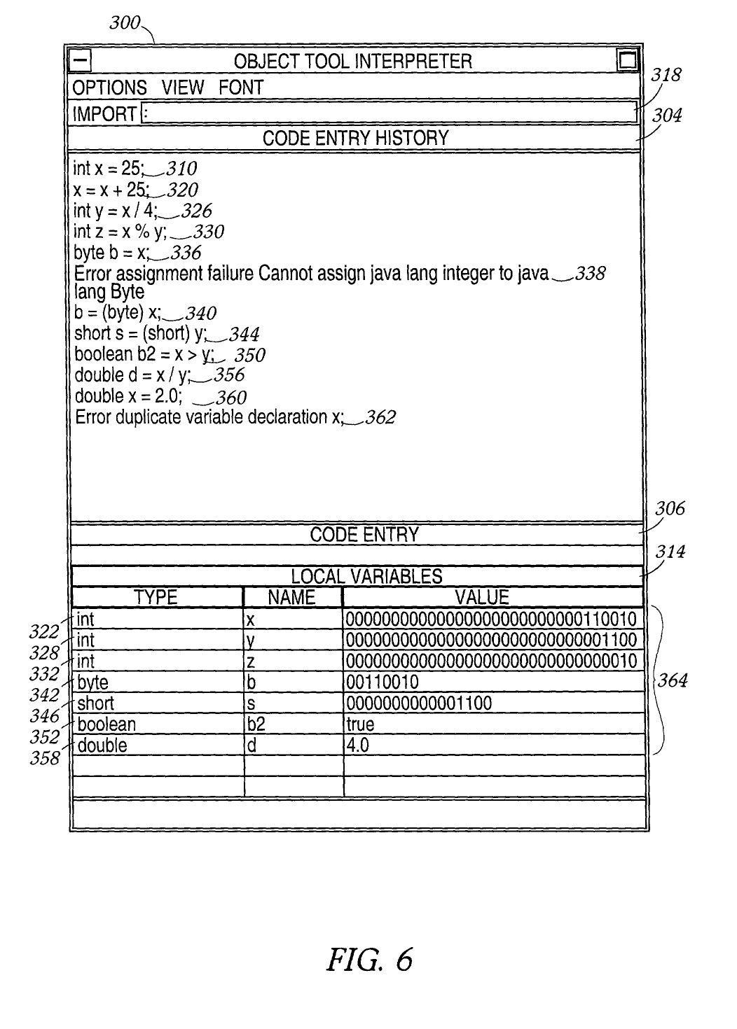

FIG. 6 illustrates the effect of a user selecting the binary semantic view of the declared and assigned variables in the local variables window 314. Such a binary toggle or selection can be made in a number of ways such as by a pull down selection of “View” in the menu bar of the interpreter interface 300. Such a change in the semantic view of the variables at 364 is especially useful for showing the semantic difference between byte, short, and integer data or variable types. FIG. 6 also includes another example of a language rules error being determined during the processing of the code entry 360 (i.e., “double x=2.0;”) as the variable has already been declared as an integer variable in code entry 310. The error cue 362 is provided to the user to allow the user to understand the error and the semantic view 358 is not updated as the code entry 360 is not executed after the errors are identified.

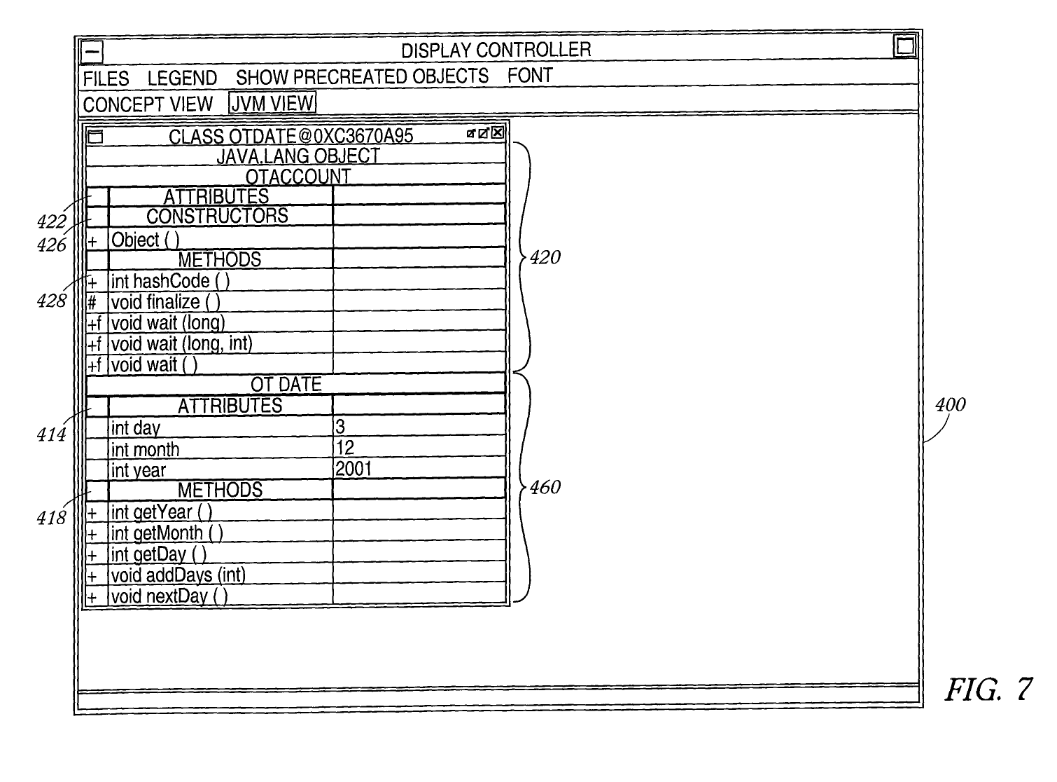

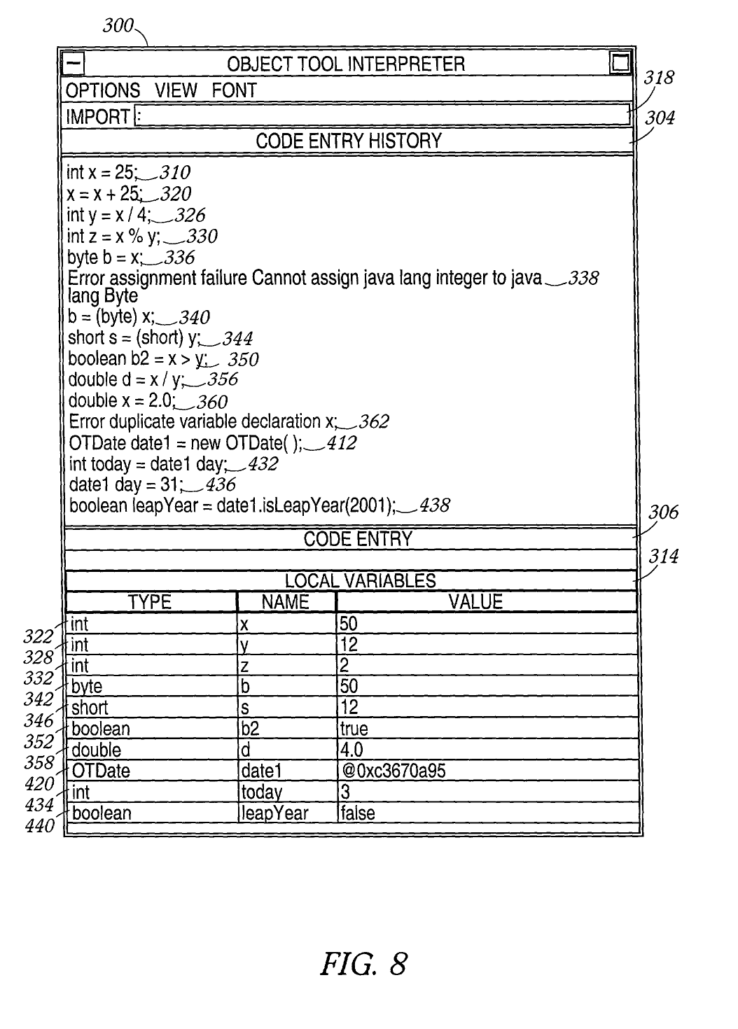

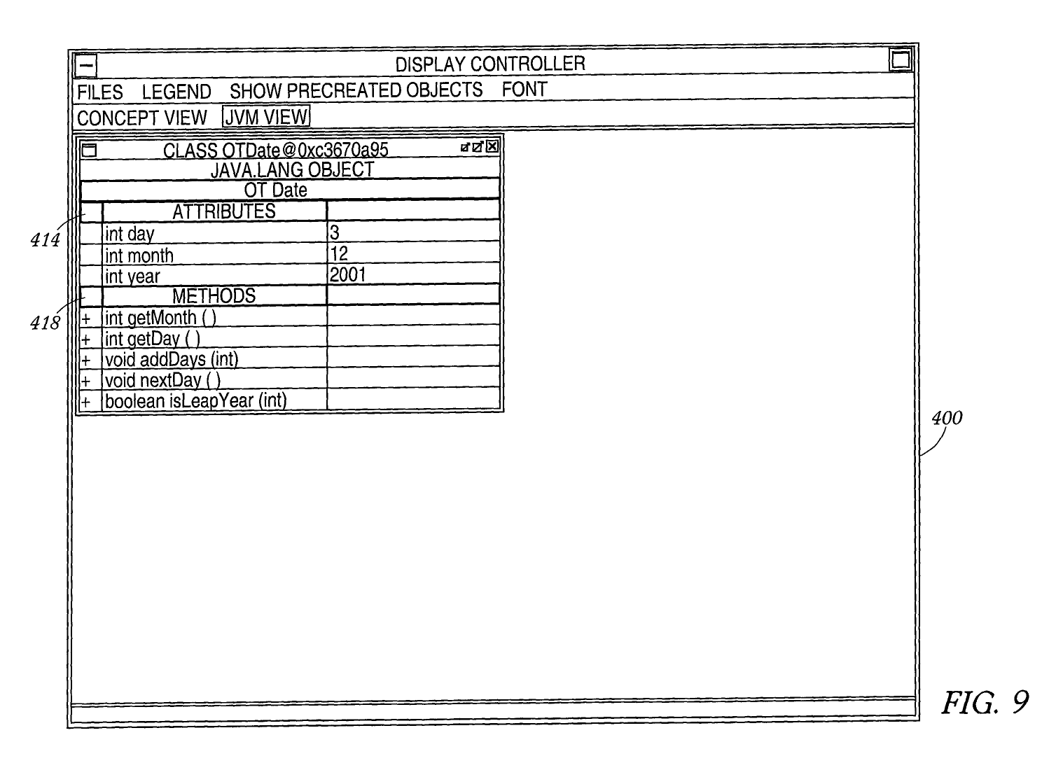

In addition to the language concept interpreter 150, the teaching tool 140 includes a display controller 152 adapted for teaching object creation and the semantic effect or view of executed code in these created objects. FIG. 7 illustrates a display controller interface 400 and FIG. 8 illustrates code entries that create and affect the appearance and/or content of the interface 400. As shown, the code entry 412 (i.e., “OTDATE date1=new OTDate( );”) in the code entry history window 304 was entered by a user and processed by the interpreter 150 with the semantic view 430 shown in local variables window 314. The display controller interface 400 is modified to display the semantic view of the OTDate object 410. The semantic view object 410 indicates the objects data type and address reference in memory as well as including attributes 414 and attribute properties. Additionally, the object view 410 includes a listing of methods and method properties 418 (and may also include constructors). In the exemplary embodiment of the interface 400, the parent object 420 for the object 410 is also shown (although only the created object 410 may be shown as shown in FIG. 9) with its attributes 422, constructors 426, and methods 428. Properties of methods and attributes of objects are quickly shown with symbols in the left hand column and the properties identified may include public, private, protected, static, and the like which may be varied to suit the underlying programming language. The teaching tool 140 provides a real time, visual teaching method for isolating object creation and manipulation concepts that enhances the learning of object-oriented programming languages.

FIG. 8 illustrates a number of code entries that can be entered to manipulate the object 410 to perform operations on reference variables. As shown, syntax checking is performed on code entry 432 (i.e., “int today=data1.day;”) and the line is executed resulting in the semantic view 434, which demonstrates reading of an attribute value in the object 410. Code entry 436 (i.e., “data1.day=31;”) is also checked for semantic and language errors and then executed by the interpreter 150, which demonstrates writing to an attribute value (as seen in semantic view 434). The code entry 438 (i.e., “boolean leapYear=data1.isLeapYear(2001);”) demonstrates to a user entry of method call and its semantic effects at 440. FIG. 9 illustrates the effects of these code entries 412, 432, 436, and 438 on the OTDate object 410.

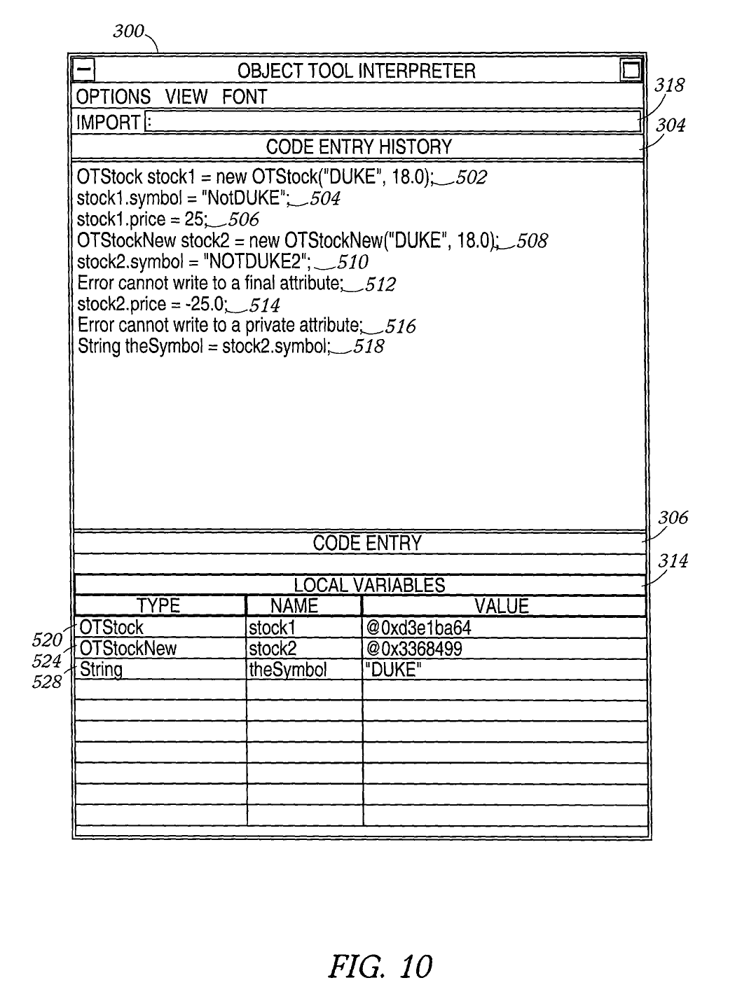

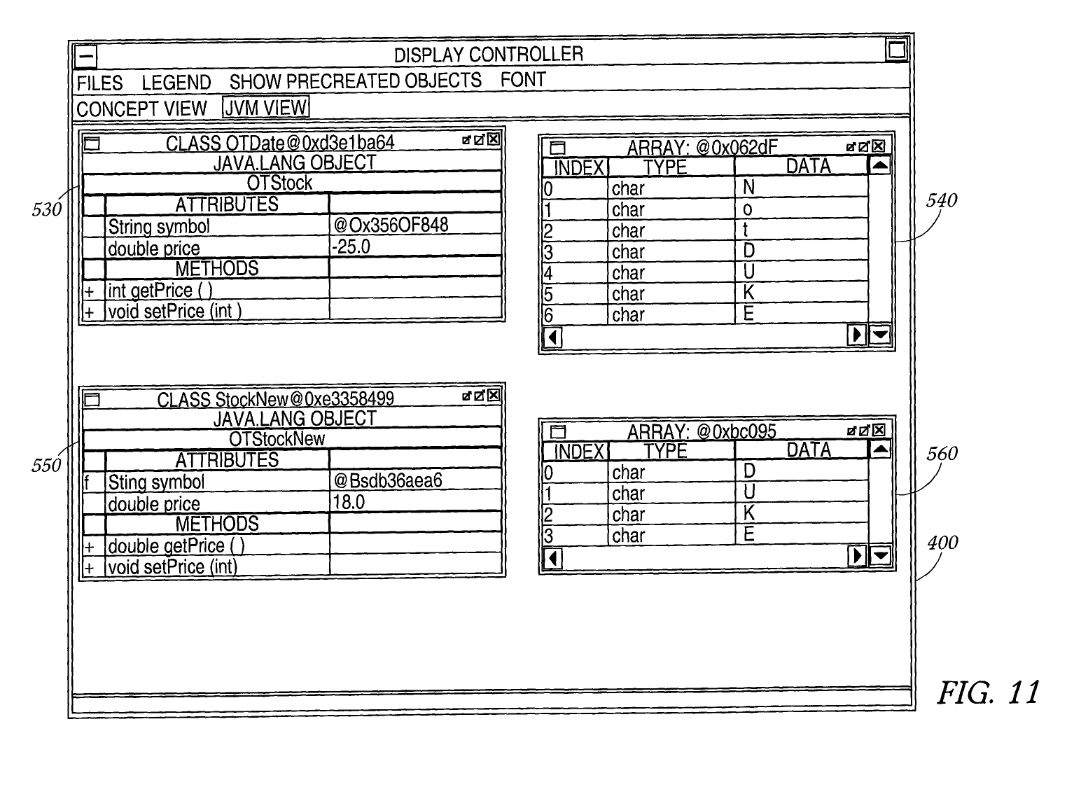

FIGS. 10 and 11 are useful for demonstrating the use of the teaching tool 140 in teaching the object concepts of encapsulation. The code entries 502, 504, 506 create an unencapsulated object with the semantic view in local variables provided at 520 and object 530 and array 540 in display controller interface 400. The code entry 508 establishes an encapsulated object 550 and array 560 with its semantic view shown at 524. Code entries 510 and 514 illustrate that code entries effective for unencapsulated object 530 result in errors being detected by the interpreter 150 and reported with error cues 514 and 516. Finally, code entry 518 illustrates the entry of a string type variable and its semantic effect at 528.

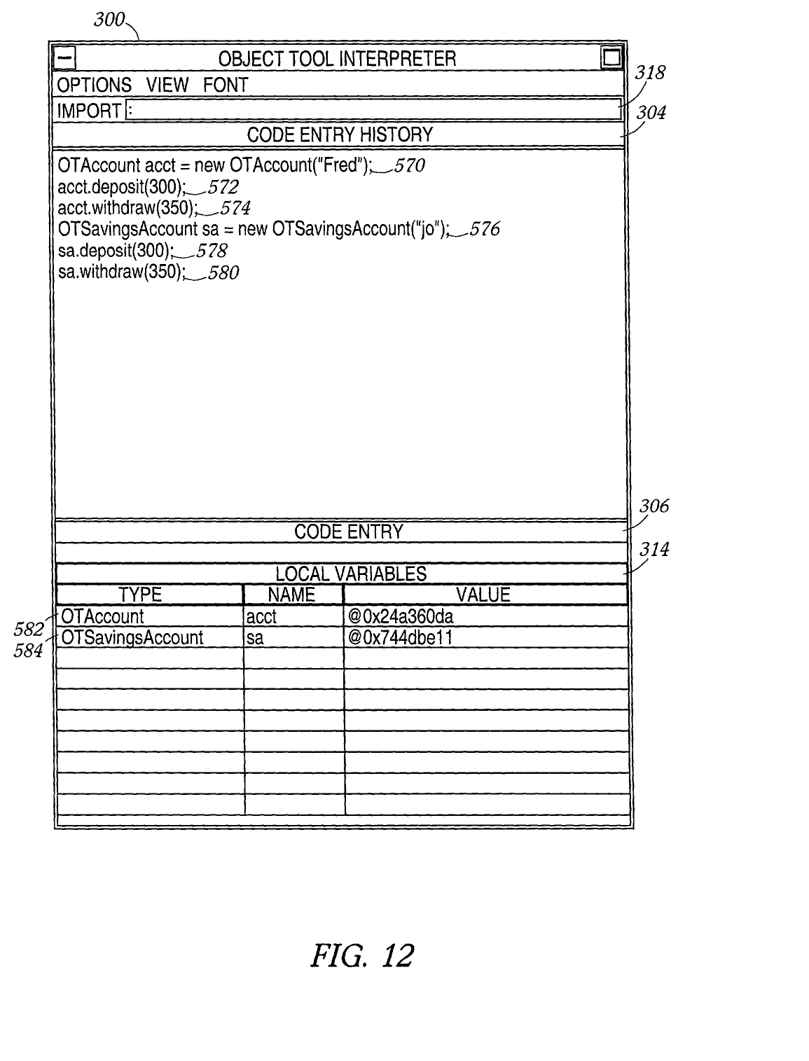

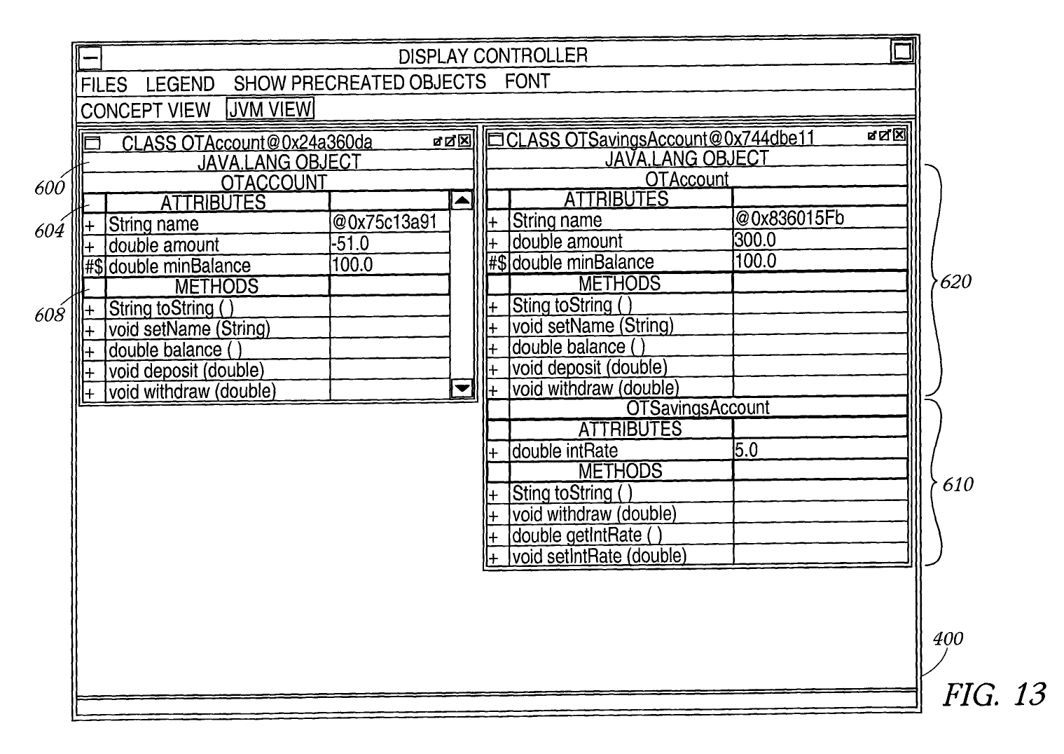

FIGS. 12 and 13 illustrate the use of the teaching tool 140 in demonstrating the object concepts of inheritance and overriding. The interpreter interface 300 view in FIG. 12 shows the creation of an OTAccount object with code entries 570, 572, and 574 and an OTSavingsAccount object with code entries 576, 578, and 580 with the semantic views shown at 582, 584. The OTAaccount object 600 is shown in FIG. 13 along with the OTSavingsAccount object 610 along with its parent object 620. The OTSavingsAccount object 610 inherits from the OTAccount object 600 and its attributes 604 and methods 608. The object 610 also, however, overrides the withdraw method. The code entries 570, 572, 574, 576, 578, 580 illustrate the syntax necessary to create the objects and call methods including overridden methods. A compressed version of the display command interface 400, e.g., one with the parent object 620 hidden, would not be effective in showing the semantic impacts of calling an overridden method. Hence, the expanded embodiment of the interface 400 is useful for showing the details of the immediate parent 620. From this view 400, the semantic impacts of calling the overridden method (i.e., withdraw method) are clearer. Note, the OTSavingsAccount object 610 overrides the OTAccount object 600 withdraw method and the OTAccount object 600 withdraw method will permit negative account balances (see, value in amount field). The OTSavingsAccount object 610 withdraw method overrides the parent object 620 behavior and will not permit negative account balances.

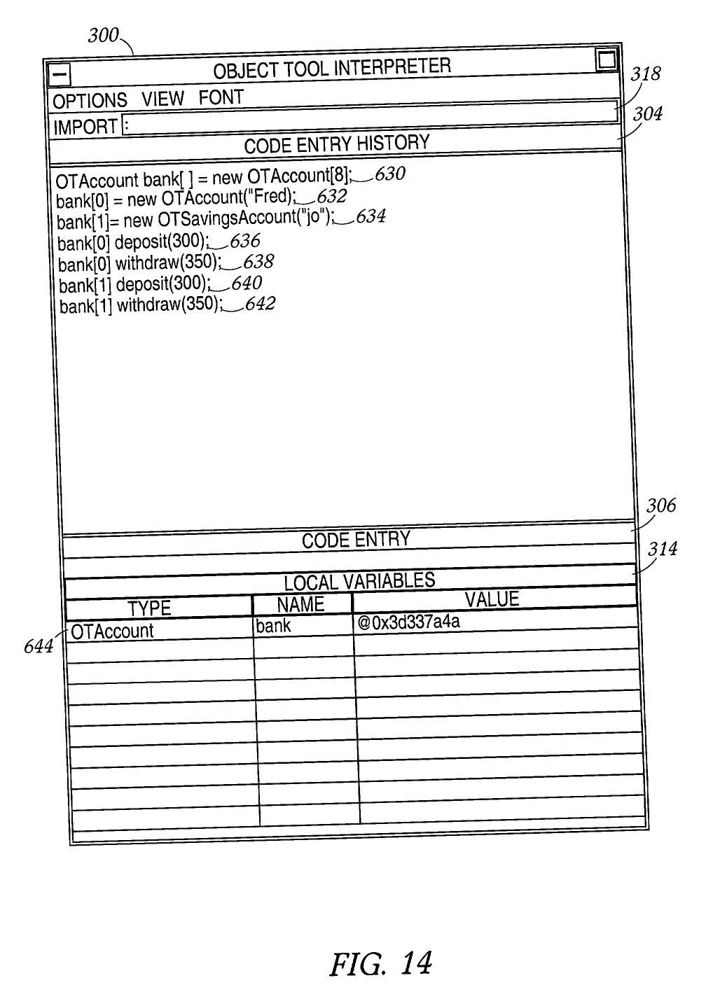

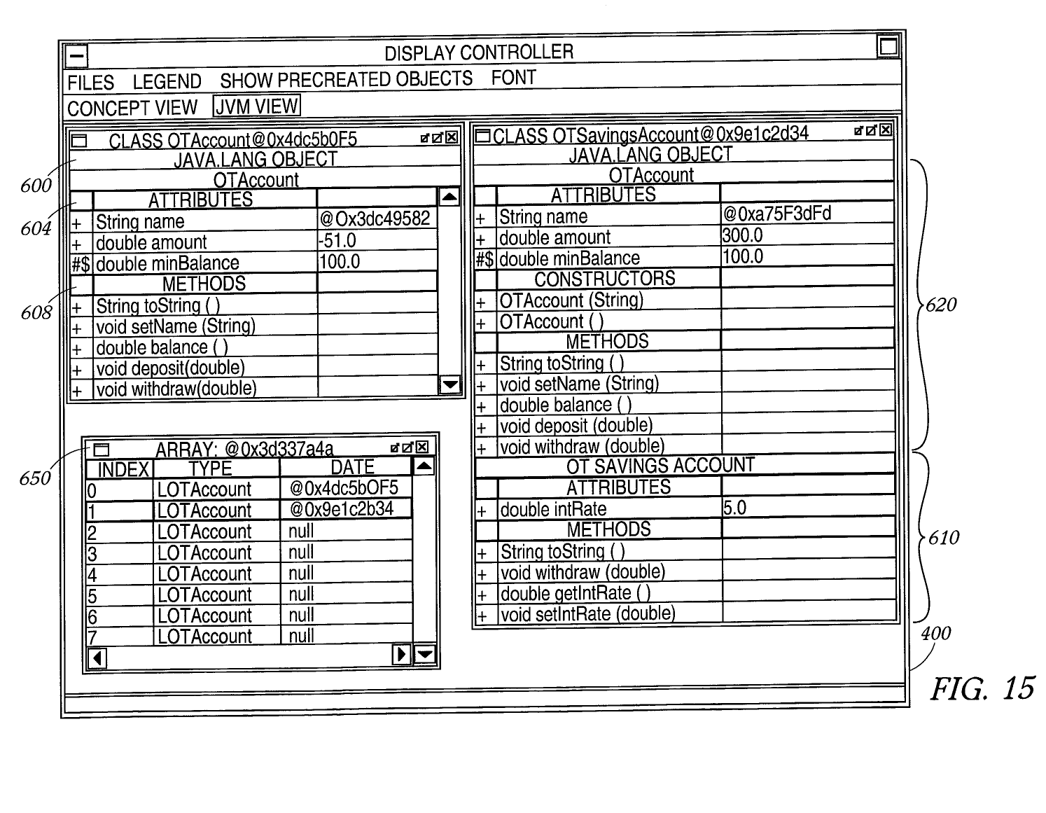

FIGS. 14 and 15 illustrates the use of the teaching tool 140 in teaching the object concept of polymorphism while also demonstrating the syntax for array declaration, creation, and population. FIG. 14 in code entry history window 304 shows the code entries 630, 632, 634, 636, 638, 640, 642 having proper syntax for creating an array of objects and operating on the elements of the array. Semantically, the array is a polymorphic collection of OTAccount objects (i.e., the OTAccount object and child objects of the OTAccount object). The semantic effect is shown at 644 of the code entry 630 and would be shown upon the execution of this command by the interpreter 150. The screen shot of display controller 400 in FIG. 15 shows OTAccount object 600 along with its attributes 604 and methods 608. Additionally, the OTSavingsAccount object 610 is shown in expanded view with its immediate parent object 620. Array 650 is also displayed in the controller interface 400. This display in controller interface 400 shows the semantic effect of using a polymorphic collection. The same methods are invoked on both elements of the bank array 650, however the impact on the objects referenced by bank[0] and bank[1] are different as shown in the amount fields of the OTAccount object 600 and the OTSavingsAccount objects 610, 620.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. In some embodiments of the invention, audio cues are also provided to the user indicating syntax errors and/or language problems with entered code. The above examples were meant to be illustrative not to provide an exhaustive listing of what concepts may be taught with the teaching tool of the invention. A key feature of the invention is the combination of a language code processor with an object viewer. These work in combination to allow a student to type in a single line of code and to interpret and execute the code to immediately provide the student with the effects of the execution in the form of visual cues. This permits the learning of concepts in isolation and empowers students to experiment and discover through experimentation and real time feedback. The teaching tool keeps track of previously entered code allowing the combination of multiple concepts and in some embodiments, any line of code that can be typed inside a method is supported or a subset of such lines of code may be supported.

We claim:

1. A method in a computer system for isolating and teaching concepts of a programming language, comprising:
providing an interpreter interface including a code entry portion adapted for receiving input from a user;
receiving a single code entry from the user via the code entry portion;
processing the code entry; and
in response to the processing, displaying a visual cue to the user.

2. The method of claim 1, wherein the processing includes comparing syntax of the code entry to a set of syntax rules for the programming language to identify a syntax error or validity of the code entry syntax.

3. The method of claim 2, wherein when the comparing identifies the syntax error, the displaying includes retrieving an error code based on the syntax error and the visual cue includes the error code.

4. The method of claim 3, wherein the visual cue further includes the received code entry.

5. The method of claim 4, wherein the interpreter interface includes a code entry history portion for displaying the error code, the received code entry, and previously received and processed code entries.

6. The method of claim 1, wherein the processing includes comparing the code entry to a set of syntax and language rules for the programming language to identify errors and when no errors are identified, executing the code entry.

7. The method of claim 6, wherein the visual cue includes displaying a semantic view of effects of the executing the code entry.

8. The method of claim 7, wherein the semantic view includes displaying a type, a name, and a value of a variable declared and assigned in the code entry.

9. The method of claim 1, wherein the displaying includes displaying objects created by or manipulated by execution of the code entry.

10. The method of claim 1, wherein the displaying includes displaying arrays created by or manipulated by execution of the code entry.

11. A computer program product for isolating and teaching concepts of a programming language, comprising:
first computer code devices configured to cause a computer to receive a programming statement from a user;
second computer code devices configured to cause a computer to process the programming statement including comparing the programming statement to syntax rules for the programming language to identify presence or absence of a syntax error in the programming statement;
and third computer code devices configured to cause a computer to display a visual cue to the user based on the identified presence or absence of the syntax error.

12. The computer program product of claim 11, further including fourth computer code devices configured to cause a computer to retrieve an error code based on the identified syntax error and wherein the visual cue includes the retrieved error code.

13. The computer program product of claim 11, wherein the first computer code devices are further configured to provide an interpreter interface including a code entry portion for performing the receiving of the programming statement and a code entry history portion for displaying at least part of the visual cue, the received programming statement, and previously received and processed programming statements.

14. The computer program product of claim 11, further including fourth computer code devices for causing a computer to execute the programming statement when the second computer code devices identifies the absence of the syntax error.

15. The computer program product of claim 14, further including fifth computer code devices for displaying to the user a semantic view of effects of the executing by the fourth computer code devices.

16. A computer system for teaching programming language concepts, comprising:
means for receiving a code entry from a user;
a syntax validator processing the received code entry based on syntax rules for the programming language to determine syntax validity or a syntax error; and
a semantic view engine displaying a semantic view to the user based on the determined syntax validity or the syntax error.

17. The computer system of claim 16, wherein the semantic view includes an error statement selected based on the syntax error.

18. The computer system of claim 17, wherein the semantic view includes effects of execution of the code entry including created variable values, object configurations, and arrays.

19. The computer system of claim 16, further including an execution engine operating to execute the code entry when the syntax is determined valid, wherein the code entry is executed based on a previously entered code entry.

20. The computer system of claim 16, wherein the receiving means includes an interface for displaying an interpreter interface with a code entry window for accepting the code entry by the user and for displaying a code entry history having previously-entered code entries and error statements corresponding to the previously-entered code entries.
